(19) United States
(12) Patent Application Publication
(10) Pub. No.: US 2002/0101222 A1
(43) Pub. Date: Aug. 1, 2002

(54) Power control apparatus and method

(76) Inventor: Jang-Hon Lee, Seoul (KR)

Correspondence Address: David Tichane, Registered Patent Attorney, 979 Pinto Palm Terrace, #24, Sunnyvale, CA, 94087, US

(21) Appl. No.: 10/011,838

(22) Filed: Dec. 5, 2001

(30) Foreign Application Priority Data
Apr. 6, 2000 (KR) PCT/KR00/00314

(51) Int. Cl. G05F 1/70; H02H 7/10; G05F 3/00

(52) U.S. Cl. 323/209; 363/50

(57) ABSTRACT

Disclosed are a power control apparatus and method thereof capable of controlling a load power by adjusting an AC power voltage supplied to a streetlamp, a computer system, and electronic equipment according to a load characteristic and object. The power control apparatus comprising: a current coil for varying a voltage; a current detecting section for detecting a current and outputting a data, an input voltage detecting section for detecting a voltage; an output voltage detecting section for detecting the voltage; a system controller for outputting a plurality of trigger control signals controlling a peripheral equipment and identifying an operation condition of a system; a switching section operated according to the plurality of trigger control signals; and an output voltage adjusting section for determining increase or decrease of the flux linkage of the current coil.

### CROSS-REFERENCE

Applicant claims priority from PCT application PCT/KR00/00314 filed Apr. 6, 2000, which named the United States.

### TECHNICAL FIELD

The present invention relates to a power control apparatus and method thereof capable of controlling a load power by adjusting an AC power voltage supplied to a streetlamp, a computer system, or electronic equipment according to a load characteristic and object. More particularly, the present invention relates to a power control apparatus and method thereof, in which after detecting and comparing the voltage inputted to a current coil and a level of the voltage outputted from the current coil, a winding number of a flux linkage coil windingly coupled to the current coil is varied by the production of a plurality of trigger signals according to the voltage inputted at the moment that input and output voltage are synchronized to each other, so that the output voltage of the current coil is adjusted, wherein by reducing the voltage when the input voltage is higher than a rated voltage, and vice versa, the load can start at the rated voltage, on increasing the load current, the above operation can be achieved, and the adjusted voltage is constantly maintained according to the set value.

### BACKGROUND ART

Generally, in order to maximize the efficiency of appliances using electricity as a driving power or an illumination such as an electrical motor, a discharge lamp, a fluorescent lamp or the like, relatively high voltage has to be needed at an initial start of a load, and after the load is driven, the power is effectively used by increasing or decreasing the voltage within an efficiency range of the load or an allowable range of an input voltage. Since the high or low voltage is applied at the initial operation, the efficiency of the appliance is decreased and the lifetime thereof is shortened. Therefore, there is a need for a power control apparatus capable of solving the above drawbacks.

In order to address the drawbacks, the applicant proposed a power control apparatus and method thereof (Korean Patent Application No 97-15239 filed on Apr. 24, 1997).

With the power control apparatus and method thereof, the voltage supplied to the load is controlled by producing and supplying a plurality of trigger signals to gates of a plurality of triacs for switching a winding number of a flux linkage coil to demagnetizing the flux of a current coil, according to the input voltage of the coil current controlling the voltage supplied to the load.

Since the power control apparatus controls the voltage supplied to the load by using the voltage supplied to the current coil, a phase difference between the output voltage and the input voltage of the current coil will be generated. Therefore, there is a drawback that the triacs for switching the winding number of the flux linkage coil may breakdown or an overvoltage may be applied to the load.

### SUMMARY OF THE INVENTION

Therefore, an object of the present invention is to solve the problems involved in the prior art and to provide power control apparatus, in which after detecting and comparing the voltage inputted to a current coil and a level of the voltage outputted from the current coil, a winding number of a flux linkage coil windingly coupled to the current coil is varied by the production of a plurality of trigger signals according to the voltage inputted at the moment that input and output voltage are synchronized to each other, so that the output voltage of the current coil is adjusted, wherein by reducing the voltage when the input voltage is higher than a rated voltage, and vice versa, the load can start at the rated voltage, on increasing the load current, the above operation can be achieved, and the adjusted voltage is constantly maintained according to the set value.

Another object of the present invention is to provide a power control apparatus capable of preventing an electrical accident caused by an electric leakage or an electric shock, thus protecting human life and preventing fire, and capable of supplying a predetermined voltage to a load regardless of the fluctuation of an input voltage.

Further, another object of the present invention is to provide a power control method capable of automatically interrupting a power supplied to a load if the leakage current is above a certain level or increased critical level, and producing an alert sound.

In order to accomplish the above mentioned objects, the present invention provides a power control apparatus comprising: a current coil for varying a voltage supplied to a load according to a flux linkage; a current detecting section for detecting a current supplied to the current coil and outputting a data corresponding to the detected current; an input voltage detecting section for detecting a voltage supplied to the current coil; an output voltage detecting section for detecting the voltage supplied to the load through the current coil; a system controller for outputting a plurality of trigger control signals according to data outputted from the input voltage detecting section and the output voltage detecting section, controlling peripheral equipment to operate the load according to a predetermined time, and identifying an operation condition of a system to output a data corresponding to the result; a switching section operated according to the plurality of trigger control signals outputted from the system controller; and an output voltage adjusting section for determining increase or decrease of the flux linkage of the current coil by varying a winding number of a flux linkage coil windingly coupled to the current coil through the switching section to adjust the voltage supplied to the load.

According to another aspect of the present invention, there is provided a power controlling method comprising the steps of. inputting data corresponding to an critical level in which a leakage current is increased during a constant time, data corresponding to a threshold leakage current and voltage, and setting a voltage supplied to a load; determining whether an input voltage inputted at a state of setting the threshold voltage is above a threshold level or not; if the input voltage is below the threshold level, detecting the voltage supplied to the load; determining whether the detected voltage is the predetermined level or not; if an output voltage is the predetermined level, supplying the output voltage to the load; at a state that the data corresponding to the increased critical level and leakage current is inputted, measuring an initial leakage current caused by the load; determining whether the initial leakage current is above the threshold level or not; if the initial leakage current is below the threshold level, automatically setting the initial leakage current to a reference leakage current; at a state that the reference leakage current is set, measuring a leakage current supplied to the load; determining whether the measured leakage current is above the threshold level or not; if the measured leakage current is below, determining whether the measured leakage current is above an increased critical level; and if the measured leakage current is above the increased critical level, displaying a leakage check, producing an alert sound, and simultaneously, interrupting supply of the power to the load.

### BRIEF DESCRIPTION OF THE DRAWINGS

The above objects, other features and advantages of the present invention will become more apparent by describing the preferred embodiment thereof with reference to the accompanying drawings, in which:

FIGS. 1 and 2 are block diagrams illustrating the construction of a power control apparatus according to the present invention.

FIG. 3 is a flow chart illustrating the operation of the power control apparatus according to the present invention.

### BEST MODE FOR CARRYING OUT THE INVENTION

The preferred embodiment of the present invention will be described in detail with reference to the accompanying drawings.

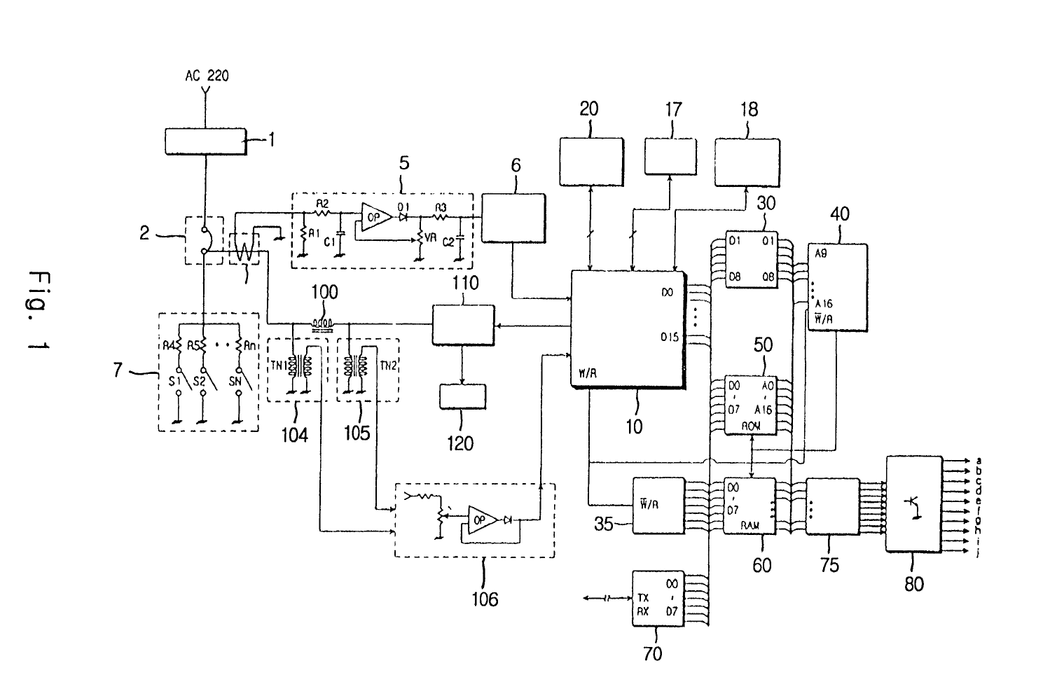

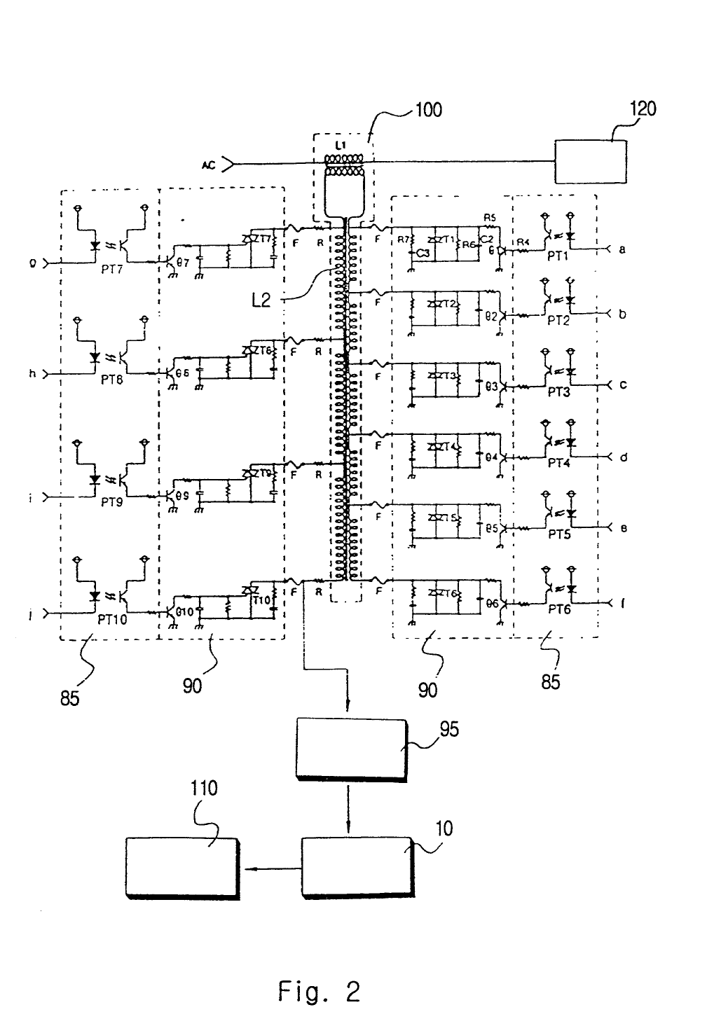

FIGS. 1 and 2 show a power control apparatus according to the present invention. Referring to FIGS. 1 and 2, a leakage detecting section 4 is connected to an output line of a mechanical earth leakage breaker 2 connected to a meter 1 to detect a leakage current. An amplifying section 5 includes an operation amplifier OP, a variable resistor VR, and resistors R1, R2, and R3 to amplify a signal outputted from the earth leakage breaker 4. An analog/digital converting section 6 includes an analog/digital converter to convert a signal amplified through the amplifying section 5 into a digital signal,

An input voltage detecting section 104 includes a compact transformer TN1 connected to a front end of a current coil L1, the current coil connected in series to a load 120 to regulate a voltage supplied to the load 120. The input voltage detecting section detects a current and voltage of an AC power inputted to an input terminal, and outputs the detected result to an input port of a system controller 10 through a first amplifying section 106. An output voltage detecting section 105 includes a compact transformer TN2 connected to a rear end of the current coil L1. The output voltage detecting section 105 detects a voltage supplied to a load 120, and outputs the detected result to the input port of the system controller 10 through the first amplifying section 106.

The system controller 10 compares a data corresponding to a leakage current outputted from the analog/digital converting section 6, a leakage current threshold level data inputted from a data input section 17, and an increased leakage current data to output a certain control signal. Also, the system controller 10 outputs a plurality of trigger control signals, according to the data outputted from the input voltage detecting section 104 and the output voltage detecting section 105. Furthermore, the system controller 10 controls peripheral equipments to operate the load according to a predetermined time, and identifies the condition of the system to output a data corresponding to the result.

A display and alarm producing section 18 displays the leakage current and input/output voltage, produces an alert sound, according to the control signal outputted from the system controller. A leakage current generating section 7 includes a plurality of switches S1 to Sn connected in parallel to a front end of the leakage detecting section 4, the switches connected in series to resistors R4 to Rn having a different resistance, respectively.

A line switching section 110 interrupts the electric power supplied to the load in response to a line switching control signal outputted from the system controller 10, when an overvoltage or overcurrent is supplied to the load, when any error is happened at the result of testing the system by which a system testing data is inputted to the input section 17, or when a leakage current above a threshold level is produced at the load.

An input voltage detecting section 104 includes a compact transformer TN1 connected to a front end of a current coil L1, the current coil connected in series to a load 120 to regulate a voltage supplied to the load 120. The input voltage detecting section detects a current and voltage of an AC power inputted to an input terminal, and outputs the detected result to an input port of a system controller 10 through a first amplifying section 106. An output voltage detecting section 105 includes a compact transformer TN2 connected to a rear end of the current coil L1. The output voltage detecting section 105 detects a voltage supplied to a load 120, and outputs the detected result to the input port of the system controller 10 through the first amplifying section 106.

A control time data storing section 20 includes a memory device for storing a time turning on the load 120 such as an illuminating lamp. An address storing section 40 includes a memory device for storing an inherent data of a power control unit.

A perpetual almanac data storing section 35 includes a memory device for storing data corresponding to the date (months, days, and years), days of the week, and hours. A latch section 30 includes a plurality of latch devices, D-type flip-flops, so that the latch section latches a data outputted from the system controller 10 to output an address signal.

An interface section 70 includes an interface for transferring the data corresponding to the test result of the system and the data corresponding to a serial number, the date, days of the week, and hours to the peripheral equipments. A buffer 75 buffers the trigger control signal outputted from the system controller 10 includes photo sensors PT1 to PT10 each driven by the trigger control signals from the system controller 10 through the buffer 75 and a second amplifying section 80, thereby preventing a high voltage induced at a flux linkage coil L2 as described below from being supplied to the system controller 10.

A switching section 90 includes transistors Q1 to Q10 switched according to the operation of the photo sensors PT1 to PT10, triacs T1 to T10 varying the winding number of the flux linkage coil L2 windingly coupled to the current coil L1 according to the operation of the transistors Q1 to Q10, and a fuse F and a high resistor R protecting the triacs T1 to T10.

A triac breakdown detecting section 95 is connected to one end of the flux linkage coil L2 of which the winding number is varied according to the operation of the triacs T1 to T10. If any one of the triacs T1 to T10 is breakdown, the triac breakdown detecting section 95 supplies a voltage of above certain voltage induced at the current coil L1 to operate the line switching section 110.

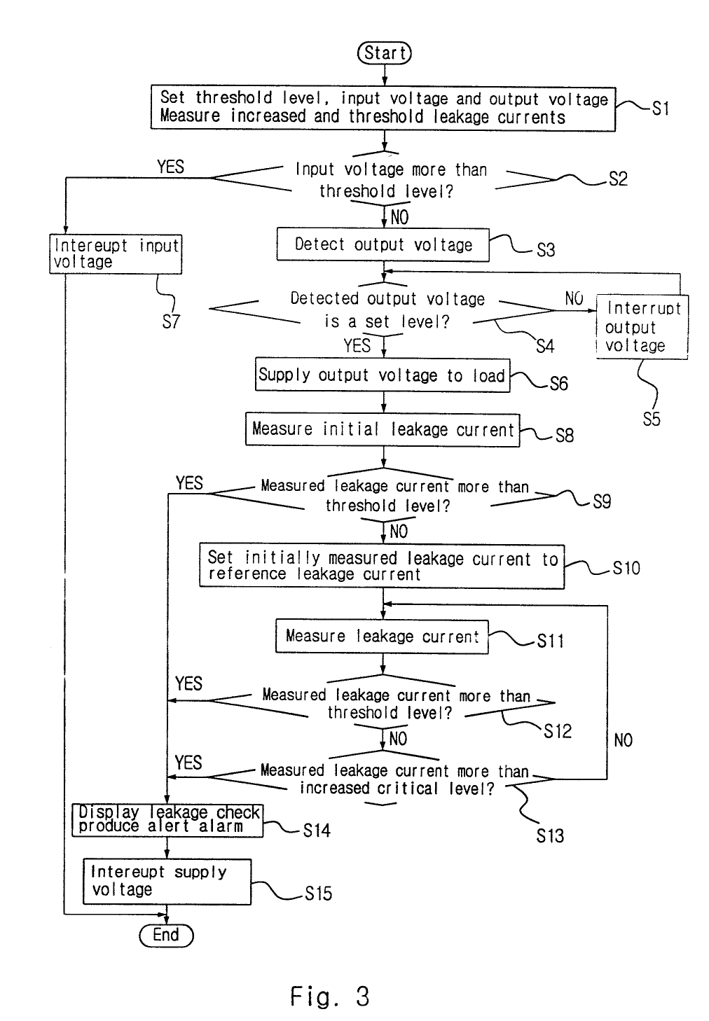

The operation of the power control apparatus according to the present invention will now be explained in detail with reference to FIG. 3.

In the state of connecting the power control apparatus of the present invention to the output terminal of the mechanical earth leakage breaker 2, if the data corresponding to the increased critical level leakage current, the data corresponding to the threshold leakage current, and the data corresponding to threshold input and output voltage, the system controller 70 scans and stores the data in a desired region of the memory, at a step S1 of FIG. 3.

If the data is stored in the memory, the system controller 10 detects the voltage that is outputted from the input voltage detecting section 104 and amplified through the first amplifying section 106, and determines whether the input voltage is above the threshold level or not (step S2). Specifically, if the input voltage is above the threshold level, the system controller supplies the switching control signal to the line switching section 1 10, thereby interrupting the input voltage to protect the load 120, at a step S7. If the input voltage is below the threshold level, the system controller detects the voltage supplied to the load 120 (step S3).

The system controller determines whether the output voltage detected at the step S3 is a predetermined level or not (step S4). If the output voltage is the predetermined level, the system controller supplies the output voltage to the load 120 (step S6). Otherwise, if the output voltage is above the predetermined level, the system controller supplied a trigger control signal to the photo sensors PT1 to PT10 of the overcurrent protecting section 85 through the buffer 75 and the second amplifying section 80, thereby adjusting the output voltage to output the voltage constantly (step S5).

For example, if the voltage of common AC power supplied to the input terminal of the apparatus of the present invention is below a certain level, the system controller 10 outputs 10 trigger signals each having 0000110000 level to the overcurrent protecting section 85 to operate the photo sensors PT5 and PT6.

If the photo sensors PT5 and PT6 operate, the transistors Q5 and Q6 of the switching section 90 are turned on to operate the triacs T5 and T6. Therefore, the winding number of the flux linkage coil of the output voltage adjusting section 100 is varied to regulate the increase/decrease of the flux linkage amount, thereby constantly outputting a constant voltage to the load 120, regardless of the level of the common AC power supplied to the input terminal.

Meanwhile, if the voltage of common AC power supplied to the input terminal of the apparatus of the present invention is above or below a certain level, the system controller 10 outputs 10 trigger signals each having 1100000000 level to the overcurrent protecting section 85. If the photo sensors PT1 and PT2 operate, the transistors Q1 and Q2 of the switching section 90 are turned on to operate the triacs T1 and T2. Therefore, the winding number of the flux linkage coil of the output voltage adjusting section 100 is varied, thereby constantly outputting a constant voltage to the load 120. When the operation of the apparatus of the present invention starts, if the input voltage is above or below a certain level, the system controller outputs different triggers, thereby supplying a constant voltage to the load 120.

The earth leakage detecting section 4 detects an initial leakage current produced by the load 120 or an electric line connected to the load, and outputs the detected current to the analog/digital converting section 6 through the operation amplifier OP of the amplifying section 5, the resistor, and the condenser. If the leakage current supplied to the analog/digital converting section 6 is converted into the digital signal to output it to the system controller 10, the system controller 10 measures the initial leakage current (step S8), and determines whether the determined initial leakage current is above the threshold level or not (step S9).

If the initial leakage current is above the threshold level, after the system controller automatically sets the initially determined leakage current to a reference leakage current (step S10), the system controller measures the leakage current (step S11). The system controller determines whether the leakage current measured at the step S11 is above the threshold level or not (step S12). If the leakage current is not above the threshold level, the system controller determines whether the leakage current is above the increased critical level or not (step S13).

If the leakage current is not above the increased critical level, the system controller continuously supplies the power to the load 120.

As the result of the determination at the steps S9, S12, and S13, if the leakage current is above the threshold or the increased critical level, the system controller supplies the driving signal to the display and alarm producing section 8, thereby displaying the leakage check and producing the alert sound (step S14). Simultaneously, the system controller operates the line switching section 110 to automatically interrupt the power supplied to the load 120 (step S15), thereby preventing the electrical leakage.

And then, the leakage current producing section 7 installed on the front end of the earth leakage detecting section 4 produces different leakage current according to the operation of the switches S1 to Sn to test whether the apparatus of the present invention automatically interrupts the power at the predetermined threshold level of leakage level. Therefore, it is possible to identify the present state of the apparatus, without using special test equipment.

### Industrial Applicability

As apparent from the above description, according to the present invention, after detecting and comparing the voltage inputted to the current coil connected in series to the load and the level of the voltage outputted from the current coil, the winding number of the flux linkage windingly coil coupled to the current coil is varied by the production of a plurality of trigger signals according to the voltage inputted at the moment that input/output voltage is matched to 0 volt. Therefore, the output voltage of the current coil is adjusted, so that the voltage supplied to the load is constantly controlled. In addition, if the input voltage is higher than a rated voltage, the winding number of the flux linkage coil windingly coupled to the current coil is adjusted, so that the flux linkage of the current coil is demagnetized. If the input voltage is less than a rated voltage, the winding number of the flux linkage coil windingly coupled to the current coil is adjusted, so that the flux linkage of the current coil is increased. Therefore, the load can start at the rated voltage, thereby increasing a lifetime of the load and eliminating a factor of reducing the efficiency thereof. In addition, on increasing the load current, the above operation can be achieved, and the adjusted voltage is constantly maintained according to the set value.

I claim:

1. A power control apparatus comprising:
a current coil for varying a voltage supplied to a load according to a flux linkage;
a current detecting section for detecting a current supplied to the current coil and outputting a data corresponding to the detected current;
an input voltage detecting section for detecting a voltage supplied to the current coil;
an output voltage detecting section for detecting the voltage supplied to the load through the current coil;
a system controller for outputting a plurality of trigger control signals according to data outputted from the input voltage detecting section and the output voltage detecting section, controlling a peripheral equipment to operate the load according to a predetermined time, and identifying an operation condition of a system to output a data corresponding to the result;
a switching section operated according to the plurality of trigger control signals outputted from the system controller; and
an output voltage adjusting section for determining increase or decrease of the flux linkage of the current coil by varying a winding number of a flux linkage coil windingly coupled to the current coil through the switching section to adjust the voltage supplied to the load.

2. The power control apparatus as claimed in claim 1, wherein the input voltage detecting section and output voltage detecting section include compact transformers each connected to a front and rear ends of the current coil to detect a voltage inputted and outputted from the load and to output a signal corresponding to the detected voltage.

3. The power control apparatus as claimed in claim 1, wherein the switching section includes transistors switched according to operation of a plurality of photo sensors, a plurality of triacs varying the winding number of the flux linkage coil windingly coupled to the current coil according to the operation of the transistors, and a fuse and a high resistor protecting the triacs.

4. The power control apparatus as claimed in any one of claims 1 to 3, wherein the output voltage adjusting section includes a plurality of coils for demagnetizing and increasing flux linkage to control the voltage supplied to the load according to operation of the switching section, the coils windingly coupled to the current coil.

5. The power control apparatus as claimed in claim 1, wherein if the voltage inputted to the current coil is coincident with a tap voltage of the flux linkage coil windingly coupled to the current coil at a zero cross, the system controller outputs a plurality of trigger signals.

6. The power control apparatus as claimed in claim 1, further comprising a triac breakdown detecting section for detecting a breakdown of the triac adjusting the output voltage by regulating the winding number of the flux linkage coil, wherein the triac breakdown is connected to one end of the flux linkage coil of which the winding number is varied according to operation of a plurality of triacs, and if any one of the triacs is breakdown, the triac breakdown detecting section supplies a voltage of above certain voltage level induced at the current coil to operate a line switching section.

7. A power control apparatus comprising:
a leakage detecting section, connected to an output line of a mechanical earth leakage breaker or an output line of a meter, for detecting a leakage current;
an analog/digital converting section for converting a signal outputted from the leakage detecting section into a digital signal;
a current coil for varying a voltage supplied to a load according to a flux linkage;
a current detecting section for detecting a current supplied to the current coil and outputting a data corresponding to the detected current;
an input voltage detecting section for detecting a voltage supplied to the current coil;
an output voltage detecting section for detecting the voltage supplied to the load through the current coil;
a system controller for comparing a data corresponding to a leakage current outputted from the analog/digital c trigger control signals according to data outputted from the input voltage detecting section and the output voltage detecting section, controlling a peripheral equipment to operate the load according to a predetermined time, and identifying an operation condition of a system to output a data corresponding to the result;
a display and alarm producing section for displaying the leakage current and input/output voltage, and producing an alert sound, according to a control signal outputted from the system controller;
a switching section operated according to the plurality of trigger control signals outputted from the system controller;
an output voltage adjusting section for determining increase or decrease of the flux linkage of the current coil by varying a winding number of a flux linkage coil windingly coupled to the current coil through the switching section to adjust the voltage supplied to the load; and
a line switching section for interrupting a voltage of electric power supplied to the load in response to a control signal outputted from the system controller, when an overvoltage or overleakage state occurs in the load.

8. A power controlling method comprising the steps of:
inputting a data corresponding to a critical level in which a leakage current is increased during a constant time, a data corresponding to a threshold leakage current and voltage, and setting a voltage supplied to a load;
determining whether an input voltage inputted at a state of setting the threshold voltage is above a threshold level or not;
if the input voltage is below the threshold level, detecting the voltage supplied to the load;
determining whether the detected voltage is the predetermined level or not;
if an output voltage is the predetermined level, supplying the output voltage to the load;
at a state that the data corresponding to the increased critical I level and leakage current is inputted, measuring an initial leakage current caused by the load;
determining whether the initial leakage current is above the threshold level or not;
if the initial leakage current is below the threshold level, automatically setting the initial leakage current to a reference leakage current;
at a state that the reference leakage current is set, measuring a leakage current supplied to the load;
determining whether the measured leakage current is above the threshold level or not;
if the measured leakage current is below, determining whether the measured leakage current is above an increased critical level; and
if the measured leakage current is above the increased critical level, displaying a leakage check, producing an alert sound, and simultaneously, interrupting supply of the power to the load.
